(19) United States
(12) Patent Application Publication
(10) Pub. No.: US 2024/0196071 A1
(43) Pub. Date: Jun. 13, 2024

(54) Video Generating Apparatus, Method and Computer Readable Recording Medium Thereof

(71) Applicant: Hyperconnect LLC, Seoul (KR)

(72) Inventor: Joon Young Lee, Seoul (KR)

(73) Assignee: Hyperconnect LLC, Seoul (KR)

(21) Appl. No.: 18/534,202

(22) Filed: Dec. 8, 2023

(30) Foreign Application Priority Data
Dec. 8, 2022 (KR) 10-2022-0170503

(51) Int. Cl. H04N 21/8549; G06V 20/40; H04N 21/234; H04N 21/2743; H04N 21/845

(52) U.S. Cl. CPC H04N 21/8549; G06V 20/41; G06V 20/44; G06V 20/47; H04N 21/23418; H04N 21/2743; H04N 21/8455

(57) ABSTRACT

Systems and methods for easily extracting images of sections from existing video and generating sub-videos are illustrated. One embodiment includes a video generating method including obtaining a target video including a plurality of frame images, wherein the target video is transmitted through a session established between two or more terminals, obtaining first frame information about at least some frame images, from among the plurality of frame images, selected to be inference targets, inputting the at least some frame images corresponding to the first frame information into an inference model to obtain content event information for extracting at least one extracted video with respect to the target video, obtaining information about a selected section of the target video based on the content event information, and generating a first extracted video based on the target video and information about the selected section.

### CROSS-REFERENCE TO RELATED APPLICATION(S)

This application claims the benefit of Korean Patent Application No. 10-2022-0170503, filed on Dec. 8, 2022, in the Korean Intellectual Property Office, the disclosure of which is incorporated herein by reference.

### FIELD OF THE INVENTION

The present invention generally relates to an apparatus that extracts and generates a video of a specific section from a long video, in addition to a method and computer-readable recording medium related thereto.

### BACKGROUND

Video platforms are divided into a live streaming platform where viewers connect and watch when a streamer broadcasts in real time, and a non-live streaming platform where viewers select the video they want to watch when recorded videos are uploaded. Accordingly, streamers broadcast on live streaming platforms, record the broadcast, edit the recorded videos, and upload the edited videos to non-live streaming platforms. This is because when the edited videos become popular on the non-live streaming platforms, a virtuous cycle occurs in which users who want to watch the videos of the streamers in real time flow into the live streaming platforms.

### SUMMARY OF THE INVENTION

Systems and methods configured in accordance with multiple embodiments of the invention used to easily extract images of sections from existing video and generate relatively short videos (including but not limited to highlight video clips and videos for reporting abusing actions) are illustrated.

Additional features and advantages of the invention will be set forth in the description which follows, and in part will be apparent from the description, and/or may be learned by practice of the invention. The objectives and other advantages of the invention will be realized and attained by the structure particularly pointed out in the written description and claims hereof as well as the appended drawings.

One embodiment includes a video generating method including obtaining a target video including a plurality of frame images, wherein the target video is transmitted through a session established between two or more terminals, obtaining first frame information about at least some frame images, from among the plurality of frame images, selected to be inference targets, inputting the at least some frame images corresponding to the first frame information into an inference model to obtain content event information for extracting at least one extracted video with respect to the target video, obtaining information about a selected section of the target video based on the content event information, and generating a first extracted video based on the target video and information about the selected section.

In a further embodiment, obtaining the target video includes obtaining the target video from a relay server while the target video is transmitted from a streamer terminal to one or more viewer terminals through the relay server.

In another embodiment, obtaining the first frame information includes transmitting, to a first event queue: the at least some frame images, session identification information of the session through which the target video is transmitted, and timestamps corresponding to the at least some frame images, and obtaining the at least some frame images, the session identification information and the timestamps stored in the first event queue as first frame information.

In a further embodiment, transmitting to the first event queue includes transmitting, to the first event queue: a selected frame image from the at least some frame images, wherein the frame image: corresponds to an I-frame and is selected as an inference target with a predetermined probability, the session identification information and a timestamp corresponding to the selected frame image.

In another embodiment, the at least some frame images corresponding to the first frame information includes I-frame images grouped based on the session identification information of the session through which the target video is transmitted.

In still another embodiment, obtaining the content event information includes transmitting session identification information and a timestamp corresponding to a particular frame image, wherein the particular frame image is selected based on inferred values of the inference model for the at least some frame images, and obtaining the session identification information and the timestamp stored in the second event queue as the content event information.

In yet another embodiment, generating the first extracted video includes specifying the target video based on the session identification information included in the content event information, and from frame images included in the specified target video, generating the first extracted video using frame images belonging to a selected section, wherein the selected section includes timepoints of timestamps included in the content event information.

In a further embodiment, the selected section includes frame images belonging to a time section that is set based on event identification information included in the content event information while including the timepoints of the timestamps included in the content event information.

In another embodiment, generating the first extracted video includes, regarding identical session identification information included in the content event information, when a content event occurs at a second timepoint within a predetermined period of time after a content event occurs at a first timepoint, when no additional content event occurs within a predetermined period of time after the content event occurs at the second timepoint, generating the first extracted video using frame images belonging to a time section including the first timepoint and the second timepoint, and when a content event occurs at a third timepoint within a predetermined period of time after the content event occurs at the second timepoint, determining whether an additional content event occurs within the predetermined period of time based on the third timepoint.

In another embodiment, the video generating method further includes applying a retention period to the plurality of frame images included in the target video and storing the frame images in a storage unit, and the first extracted video may be generated using at least some of the frame images stored in the storage.

In yet another embodiment, the video generating method further includes transmitting the target video to at least one of: one or more viewer terminals, or a streamer terminal scheduled to transmit the target video.

In still yet another embodiment, the video generating method further includes transmitting the generated first extracted video to one or more viewer terminals or the streamer terminal scheduled to transmit the first extracted video.

In another embodiment, the video generating method further includes uploading the generated first extracted video to a content delivery network (CDN), and receiving address information referring to the uploaded first extracted video.

In another embodiment, the video generating method further includes uploading the generated first extracted video to one or more contents hosting at least one of platforms, or social network platforms under the name of the pre-linked account.

In yet another embodiment, the inference model receives frame images included in each of a plurality of different target videos in batch form and infers whether each frame image is a frame image suitable for serving as reference for video extraction.

In still another embodiment, the inference model individually receives one or more frame images included in a second target video and infers whether each frame image of the one or more frame images is suitable for serving as reference for video extraction.

In another embodiment, the inference model includes a first sub-inference model that receives a set of frame images included in each of a plurality of different target videos in batch form and firstly infers whether each frame image in the set of frame images is suitable for reference for video extraction, and a second sub-inference model that receives at least one frame image determined to be a reference for video extraction according to a result of the first inference by the first sub-inference model, individually for each of the plurality of target videos, and secondly infers whether each frame image in the set of frame images is suitable for serving as a reference for video extraction.

In still another embodiment, the inference model may include a text conversion module that converts each of one or more texts defined in relation to a content event into a first embedding vector, an image conversion module that converts a particular frame image that is input to the inference model into a second embedding vector, a correlation degree calculation module that calculates correlation degrees between the first embedding vector and the second embedding vector, and an output module that, when a correlation degree that is higher than or equal to a threshold correlation degree that is set for each of the one or more texts is present among the calculated correlation degrees, outputs an inferred value indicating at least one frame image corresponding to the correlation degree that is higher than or equal to the threshold correlation degree.

One embodiment includes a video generating method including obtaining a target video including a plurality of frame images, receiving a recording request from a terminal connected to a session through which the target video is transmitted, and generating a second extracted video using frame images corresponding to session identification information of the session through which the target video is transmitted and a timestamp of a timepoint of the recording request.

One embodiment includes an apparatus including an input/output interface, a memory for storing instructions, and a processor, wherein the processor, connected to the input/output interface and the memory, is configured to obtain a target video including a plurality of frame images, obtain first frame information corresponding to at least some frame images, from among the plurality of frame images, selected to be inference targets, input the at least some frame images corresponding to the first frame information into an inference model to obtain content event information for extracting at least one extracted video with respect to the target video, obtain information about a selected section of the target video based on the content event information, and generate a first extracted video based on the target video and information about the selected section.

One embodiment includes a non-transitory computer-readable recording medium having a program for executing the video generating method.

One embodiment includes a video processing system including a relay server that receives from a streamer terminal a target video including a plurality of frame images, wherein the target video is transmitted through a session established between two or more terminals, and that transmits the target video to a video processing server and/or a storage unit, a video processing server that receives the target video from the relay server, obtains first frame information about at least some frame images, selected to be inference targets, inputs the at least some frame images corresponding to the first frame information into an inference model to obtain content event information for extracting at least one extracted video with respect to the target video, obtains information about a selected section of the target video based on the content event information, and generates a first extracted video based on the target video and information about the selected section, and a storage unit that receives the target video from the relay server and stores the target video by applying a retention period to the plurality of frame images included in the target video.

Additional aspects of example embodiments will be set forth in part in the description which follows and, in part, will be apparent from the description, and/or may be learned by practice of the disclosure. A further understanding of the nature and advantages of the present invention may be realized by reference to the remaining portions of the specification and the drawings, which form a part of this disclosure.

According to multiple embodiments of the invention, it is possible to reduce the cost of video recording compared to converting all frame images to a video by extracting frame images selected from a video and generating a shorter video.

For example, by inferring frame images appropriate for a specific event through an inference model and generating a short video, video recording may be automatically performed depending on a type of event.

For another example, by receiving a recording request from a terminal connected to a session through which the video is transmitted and generating a short video, it is possible to cost-effectively record video only for a section desired by a user.

Effects of the present disclosure are not limited to those described above, and other effects may be made apparent to those skilled in the art from the following description.

### BRIEF DESCRIPTION OF THE DRAWINGS

The description and claims will be more fully understood with reference to the following figures, which are presented as exemplary embodiments of the invention and should not be construed as a complete recitation of the scope of the invention. These and/or other aspects, features, and advantages of the invention will become apparent and more readily appreciated from the following description of example embodiments, taken in conjunction with the accompanying drawings of which:

FIG. 1 is a schematic diagram illustrating an environment in which a video generating apparatus operates in accordance with many embodiments of the invention;

FIG. 2 is a flowchart illustrating a video generating method in accordance with multiple embodiments of the invention;

FIG. 3 is a flowchart explaining a process for obtaining first frame information performed in accordance with some embodiments of the invention;

FIG. 4 is a flowchart explaining a process for obtaining content event information performed in accordance with a number of embodiments of the invention;

FIGS. 5-6 are flowcharts explaining processes for generating first extracted videos, performed in accordance with several embodiments of the invention;

FIGS. 7 to 10 are flowcharts explaining a video generating method performed in accordance with a number of embodiments of the invention;

FIG. 11 is a flowchart illustrating a video generating method performed in accordance with certain embodiments of the invention;

FIG. 12 is an exemplary diagram illustrating a video generating process performed in accordance with multiple embodiments of the invention;

FIG. 13 is an exemplary diagram illustrating an input/output process of an inference model performed in accordance with multiple embodiments of the invention; and

FIG. 14 is a block diagram explaining a video generating apparatus implemented in accordance with various embodiments of the invention.

### DETAILED DESCRIPTION

The video platform market is growing. For example, previously, only a small number of professional steamers broadcasted, but now a significant number of ordinary people also broadcast for purposes such as marketing and profit generation. In particular, with the advancement of technology, the communication delay between streamers and viewers has been greatly reduced, making almost real-time communication possible, and entry by the general public is becoming more active.

However, in the case of the general public, it is difficult to fully pay the cost of recording a broadcast on a live-streaming platform due to a lack of investment capital and time. Further, even if the broadcast is recorded, it is not easy to generate a video to upload to a non-live streaming platform, as the time required for video editing is limited and editing skills of the public are often rudimentary.

Systems and methods configured in accordance with certain embodiments of the invention may be used extract and generate videos of specific sections from long videos.

Hereinafter, specific example embodiments are described with reference to the drawings. The following detailed description is provided for comprehensive understanding of the methods, apparatus, and/or systems described herein. However, the example embodiments are only for understanding and the present disclosure is not limited to the detailed description.

In describing many embodiments, when it is determined that a detailed description of the related known technology may unnecessarily obscure the gist of the disclosed embodiments, the detailed description may be omitted. In addition, the terms to be described later are terms defined in consideration of functions in the example embodiments of the present disclosure, which may vary according to intentions or customs of users and operators. Therefore, the definitions should be made based on the content throughout the present disclosure. The terms used in the detailed description are for the purpose of describing the embodiments only, and the terms should never be restrictive. Unless explicitly used otherwise, expressions in the singular include the meaning of the plural. In the present disclosure, expressions such as “include” or “comprise” are intended to refer to certain features, numbers, steps, acts, elements, some or a combination thereof, and the expressions should not be construed to exclude the presence or possibility of one or more other features, numbers, steps, acts, elements, or some or combinations thereof other than those described.

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in these cases, the meaning will be described in detail in the corresponding descriptions. Therefore, the terms used in the present disclosure should be defined based on the meaning of the terms and the contents of the present disclosure, rather than the simple names of the terms.

Throughout the specification, when a part is described as “comprising or including” a component, it does not exclude another component but may further include another component unless otherwise stated. Furthermore, terms such as “ . . . unit,” “ . . . group,” and “ . . . module” described in the specification mean a unit that processes at least one function or operation, which may be implemented as hardware, software, or a combination thereof. Unlike those used in the illustrated embodiments, the terms may not be clearly distinguished in specific operations.

The expression “at least one of a, b or c” described throughout the specification may include “a alone,” “b alone,” “c alone,” “a and b,” “a and c,” “b and c” or “all of a, b and c.”

In the following description, terms “transmission,” “communication,” “sending,” “receiving” and other similar terms not only refer to direct transmission of a signal or information from one component to another component, but may also include transmission via another component.

In particular, to “transmit” or “send” a signal or information to an element may indicate a final destination of the signal or information, and may not imply a direction destination. The same is applied to “receiving” a signal or information. In addition, in the present disclosure, when two or more pieces of data or information are “related,” it indicates that when one piece of data (or information) is obtained, at least a part of the other data (or information) may be obtained based thereon.

Further, terms such as first and second may be used to describe various components, but the above components should be not limited by the above terms. The above terms may be used for the purpose of distinguishing one component from another component.

For example, without departing from the scope of the present disclosure, a first component may be referred to as a second component. Similarly, the second component may also be referred to as the first component.

In describing the example embodiments, descriptions of technical contents that are well-known in the technical field to which the present disclosure pertains and that are not directly related to the present disclosure will be omitted. This is meant to more clearly convey the gist of the present disclosure without obscuring the gist of the present disclosure by omitting unnecessary description.

For the same reason, some elements are exaggerated, omitted or schematically illustrated in the accompanying drawings. In addition, the size of each element does not fully reflect the actual size. In each figure, the same or corresponding elements are assigned the same reference numerals.

Advantages and features of the present disclosure, and methods of achieving the advantages and the features will become apparent with reference to the certain embodiments described below in detail together with the accompanying drawings. However, the present disclosure is not limited to the example embodiments disclosed below, and may be implemented in various different forms. The example embodiments are provided only so as to render the present disclosure complete, and completely inform the scope of the present disclosure to those of ordinary skill in the art to which the present disclosure pertains. The present disclosure is only defined by the scope of the claims. Like reference numerals refer to like elements throughout.

It will be understood that each block of a flowchart diagram and a combination of the flowchart diagrams may be performed by computer program instructions. The computer program instructions may be embodied in a processor of a general-purpose computer and/or a special-purpose computer, and/or may be embodied in a processor of other programmable data processing equipment. Thus, the instructions, executed via a processor of a computer or other programmable data processing equipment, may generate a part for performing functions described in the flowchart blocks. To implement functions in a particular manner, the computer program instructions may, additionally or alternatively be stored in computer-usable and/or computer-readable memory that may direct computers and/or other programmable data processing equipment. Thus, the instructions stored in the computer-usable and/or computer-readable memory may be produced as articles of manufacture containing instruction parts for performing the functions described in the flowchart blocks. The computer program instructions may be embodied in computers and/or other programmable data processing equipment. Thus, a series of operations may be performed in computers and/or other programmable data processing equipment to create computer-executed processes, and the computers and/or other programmable data processing equipment may provide steps for performing the functions described in the flowchart blocks.

Additionally or alternatively, each block in a flowchart may represent a module, a segment, and/or a portion of code that includes one or more executable instructions for executing a specified logical function(s). It should also be noted that, in some alternative implementations, the functions recited in the blocks may occur out of order. For example, two blocks shown one after another may be performed substantially at the same time. Additionally or alternatively, blocks may sometimes be performed in the reverse order according to a corresponding function.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

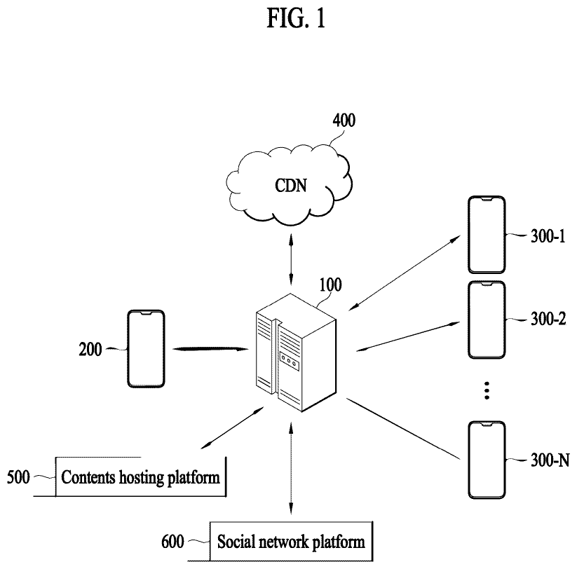

A schematic diagram depicting an environment in which a video generating apparatus configured in accordance with various embodiments is illustrated in FIG. 1. Referring to FIG. 1, a video generating apparatus 100 operates while exchanging data with a streamer terminal 200, a viewer terminal 300-1, a viewer terminal 300-2, . . . and a viewer terminal 300-N, a content delivery network (CDN) 400, a contents hosting platform 500 and a social network platform 600. In accordance with several embodiments, some of the viewer terminal 300-1, the viewer terminal 300-2, . . . , the viewer terminal 300-N, the CDN 400, the contents hosting platform 500 and the social network platform 600 may be omitted in accordance with some embodiments.

In accordance with numerous embodiments, video generating apparatus(es) 100 may extract a video of a partial section, that may be inferred from video obtained from external sources (for example, the streamer terminal 200, the viewer terminal 300-1, the viewer terminal 300-2, . . . , the viewer terminal 300-N, and/or a relay server). In accordance with some embodiments, the video may be extracted through an inference model, and the video generating apparatus(es) 100 may generate a highlight video in which one or more specific events are recorded and/or report video (e.g., upon detecting including an act against regulations with respect to an existing video). For example, video generating apparatus(es) 100 may extract video of a section, inferred by an inference model wherein events in which a streamer claps are recorded, and/or may extract video of a section, inferring that a viewer transmitted a chatting message containing profanity to a streamer. For this, the video generating apparatus(es) 100 may include storage to store the obtained video, an event queue that temporarily stores information for video extraction, a model control module that exchanges data with the inference model, and/or a video processing module that generates extracted video using frame images of a partial section from the storage. In accordance with various embodiments, video generating apparatus(es) 100 may further include storage for video storing and/or inference model(s) for performing inference on an image.

Further, according to another example embodiment, video generating apparatus(es) 100 may obtain video from the outside and extract video of a section corresponding to the timepoint when the streamer terminal 200 and/or one of the viewer terminals (e.g., the viewer terminal 300-1, the viewer terminal 300-2, . . . , and the viewer terminal 300-N) requests recording. For this, the video generating apparatus(es) 100 may include but are not limited storage for storing the obtained video and a video processing module for generating an extracted video using frame images of a partial section from the storage. Further, in accordance with certain embodiments, the video generating apparatus(es) 100 may further include storage to store video.

In accordance with many embodiments, a streamer and/or a viewer may obtain summary video in which necessary sections are automatically extracted without separate recording requests. Additionally or alternatively, they may obtain a summary video from which a specific section is extracted simply by a request for recording at a necessary time. In other words, not only full-time streamers, but also ordinary people who have newly entered a video platform may easily create summary videos, and thus summary videos may be uploaded to the CDN 400 and/or to various types of video platforms (for example, the contents hosting platform 500 and the social network platform 600) and/or video streaming to the same for marketing and profit generation.

Each of the elements illustrated in FIG. 1 can communicate with each other within the network in accordance with certain embodiments. The communication network may include but is not limited to a local area network (LAN), a wide area network (WAN), a value added network (VAN), a mobile radio communication network, a satellite communication network, and combinations thereof. The communication network is a data communication network in a comprehensive sense that enables the constituent entities shown in FIG. 1 to communicate smoothly with each other, and may include a wired Internet, a wireless Internet, and a mobile wireless communication network. Examples of wireless communication may include wireless LAN (Wi-Fi), Bluetooth, Bluetooth low energy, ZigBee, Wi-Fi direct (WFD), ultra-wideband (UWB), infrared data association (IrDA) and near field communication (NFC), but is not limited thereto.

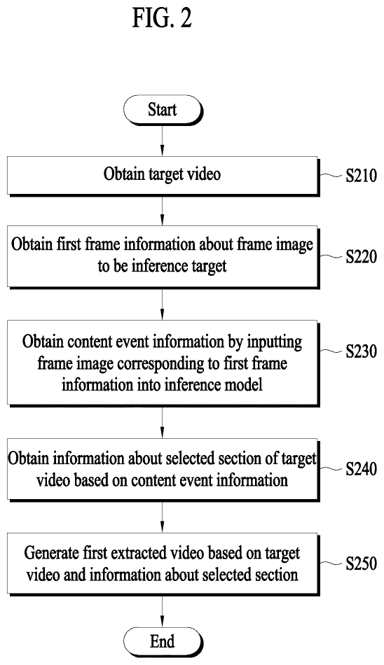

With regard to the above, it will be described in more detail through the following drawings. A method described below with reference to FIGS. 2 to 11 may be performed by a video generating apparatus 100, but the method may be performed by using an additional entity in addition to the video generating apparatus 100.

A flowchart depicting a video generating method implemented in accordance with numerous embodiments of the invention is illustrated in FIG. 2. Process S200 may be performed by systems including but not limited to the video generating apparatus 100 disclosed in FIG. 1.

Process S200 obtains (S210) a target video including a plurality of frame images. In accordance with multiple embodiments, process S200 may receive the target video from streamer terminals and/or relay servers. Additionally or alternatively, the target video(s) used by process S200 to extract a video through the following process may be a copy. In accordance with multiple embodiments, the original of the target video(s) may be stored separately in storage space of the video generating apparatus(es) and/or in storage space of the streamer terminals. In accordance with various embodiments, the original of the target video(s) may be stored in storage external to the video generating apparatus(es), where copies of the target video(s) may be temporarily stored, and/or in storage included in the video generating apparatus(es).

In accordance with several embodiments, while the target video is being transmitted from the streamer terminal(s) to one or more viewer terminals through the relay server, the video generating apparatus(es) may obtain the target video from the relay server.

In accordance with many embodiments, in addition to the target video(s), the video generating apparatus(es) may obtain session identification information of sessions through which the target video is transmitted and/or identification information of the streamer(s) who broadcast the target video(s).

In accordance with a number of embodiments, the target video(s) obtained by the video generating apparatus(es) may include but is not limited to I-frame images (e.g., an I-frame, an intra frame) that do not refer to other frame images within the target video(s) and P-frame images (e.g., a P-frame, a predicted frame) that is stored by differences from the I-frame image(s) being predicted.

The I-frame image(s) may include, but are not limited to the following characteristics. First, the target video(s) may be restored simply by using I-frame images. Second, inference results and/or prediction results for I-frame image(s) may be extended and applied to images of surrounding frame images temporally adjacent to the relevant I-frame image(s).

In accordance with some embodiments, the video generating apparatus(es) may store the obtained target video in storage external to the video generating apparatus(es) and/or storage included in the video generating apparatus(es).

Process S200 identifies (S220) first frame information about at least some frame images to be inferred among the plurality of frame images. In accordance with multiple embodiments, the first frame information identified by process S200 may include but is not limited to frame images selected as inference targets, session identification information of the session through which the target video is transmitted and timestamps corresponding to the selected frame images.

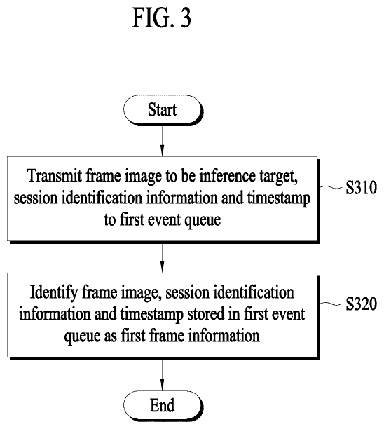

An example process for performing operation S220 in accordance with multiple embodiments of the invention, is illustrated in FIG. 3. More specifically, as shown in FIG. 3, process S300 transmits (S310) the frame images to be the inference targets to a first event queue, the session identification information of the session through which the target video is transmitted and the timestamps corresponding to the frame images to be inferred in operation S310. Process S300 obtains (S310) the frame images, the session identification information and the timestamps stored in the first event queue as first frame information. In accordance with various embodiments, the first event queue may include architectures based on systems including but not limited to Apache Kafka. Further, in accordance with numerous embodiments, the function of identifying the first frame information from the first event queue may be implemented through an architecture based on systems including but not limited to Apache Flink.

Here, as an example embodiment in relation to operation S310, process S300 may transmit all I-frame images included in the target video to the first event queue. Additionally or alternatively, process S300 may randomly select I-frame image(s) included in the target video with a certain probability and transmit the I-frame image(s) to the first event queue. Additionally or alternatively, process S300 may select I-frame image(s) in a specific order among the I-frame images included in the target video and transmit the I-frame image(s) to the first event queue. In other words, the frame images that the process S300 transmits from the target video to the first event queue may be all I-frame images included in the target video and/or may be some I-frame images that are selected in consideration of the cost or resources required to transmit the images.

Referring back to FIG. 2, process S200 inputs (S230) the frame images corresponding to first frame image information (identified through operation S220) into an inference model to obtain content event information for extracting video with respect to the target video. Specifically, video generating apparatus(es) configured in accordance with multiple embodiments may input the frame images corresponding to the first frame information into the inference model(s) and identify content event information that is a reference for video extraction based on the output of the inference model.

In accordance with several embodiments, a set of images corresponding to the first frame information may include I-frame images grouped based on the session identification information of the session through which the target video is transmitted. Specifically, the frame images corresponding to the first frame information may be in a set in which I-frame images corresponding to the same session identification information are grouped. For this operation, process S200 may temporarily store the I-frame images with the same session identification information in a cache. When a certain number of I-frame images with the same session identification information are temporarily stored, and/or when the I-frame images with the same session identification information are temporarily stored for a certain period of time or longer, process S200 may input temporarily stored frame images into the inference model(s).

In accordance with various embodiments, among a plurality of frame images included in the target video(s), the frame images corresponding to the first frame information may include frame images that correspond neither to (1) an I-frame image nor (2) a frame image, but satisfy a set timepoint condition, a time section condition, a sequence condition, and/or a capacity condition. In accordance with some embodiments, the frame image(s) may include P-frame image(s) and/or B-frame image(s) (a B-frame, a bidirectional frame), which are not I-frame images. Additionally or alternatively, the frame image(s) may correspond to specific timepoints that are included in specific time sections, corresponding to specific sequence numbers, and/or below certain capacities.

In accordance with some embodiments, the inference model(s) may be implemented on servers separate from the video generating apparatus(es) (for example, the Triton inference server), but the inference model(s) are not limited thereto. Further, in accordance with a number of embodiments, the inference model(s) may be implemented in memory within the video generating apparatuses.

In accordance with multiple embodiments, the inference model(s) may be selected based on the time and computing resources required for inference. The inference model may be a model that receives frame images of multiple target videos at once and performs inference, and/or may be a model that performs inference by receiving only frame images of one target video at a time. In the former case, the inference model may be a model that receives frame images included in each of a plurality of different target videos in batch form and infers whether each frame image is a frame image that can be a reference for video extraction. However, in the latter case, the inference model may be an inference model that individually receives one or more frame images included in one target video and infers whether each frame image is a frame image suitable for serving as reference for video extraction. As a result, the former case performs inference by receiving frame images from different broadcasts or different target videos, so the former case has the disadvantage of taking a long time (slow speed) for inference, but is cost-effective. The latter case performs inference for each target video, so the latter case has the disadvantage of high inference costs (consuming a lot of computing resources) but has the advantage of a short inference time.

Further, in accordance with several embodiments, the inference model may be a mixture of the two types of models and may be a model that performs inference twice. In other words, the inference model may include a first sub-inference model that receives frame images included in each of a plurality of different target videos in batch form and first infers whether each frame image is a frame image that can be a reference for video extraction, and a second sub-inference model that receives frame images that are determined to be a reference for video extraction according to results of the first inference individually for each target video, and makes a second inference as to whether each frame image is a frame image that can be a reference for video extraction. The structure of the inference model is intended to increase the accuracy of inference through two inferences while compromising the computing resources and time required for inference.

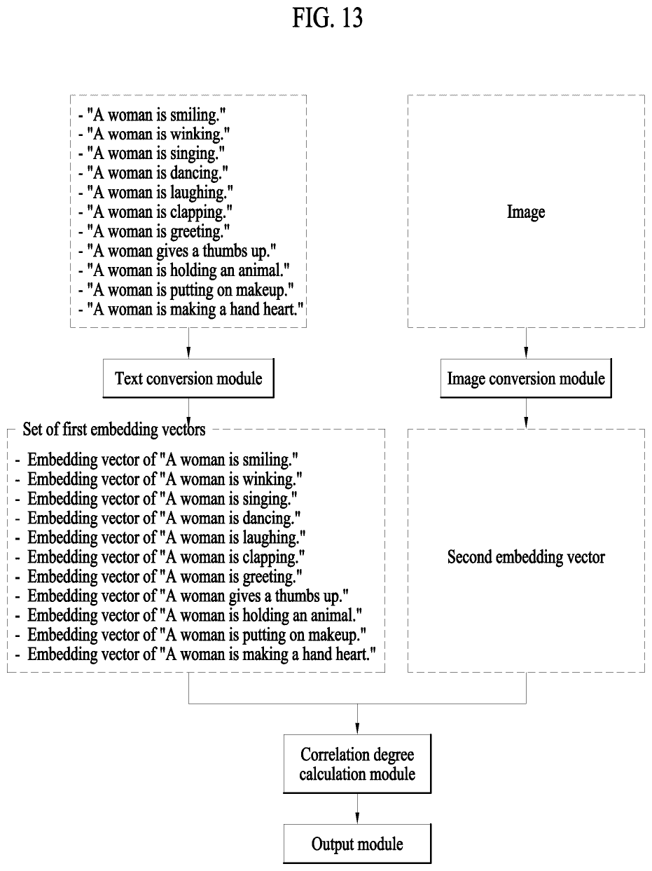

Further, in accordance with numerous embodiments, the inference models (and/or sub-inference models) can compare text representing events of videos and frame images input into the inference models (and/or the sub-inference models). Additionally or alternatively, they may identify the type of event corresponding to an input frame image according to the degree of similarity between the two. For the operation, the inference models (and/or the sub-inference models) may include but are not limited to the following detailed elements. With regard thereto, descriptions will be made with reference to FIG. 13 below.

A first detailed element is a text conversion module that converts each of one or more texts defined in relation to a content event into a first embedding vector.

A second detailed element is an image conversion module that converts frame image(s) that is input to the inference models (and/or the sub-inference models) into a second embedding vector.

A third detailed element is a correlation degree calculation module. The correlation degree calculation module can calculate the correlation degrees between each first embedding vector and the second embedding vector.

A fourth detailed element is an output module. When, among the calculated correlation degrees, there is a correlation degree higher than or equal to a threshold correlation degree that is set for each text, the output module can output an inferred value indicating at least one frame image corresponding to the correlation degree higher than or equal to the threshold correlation degree. For example, the output module may output an inferred value indicating a frame image corresponding to the maximum correlation degree among correlation degrees that are higher than or equal to the threshold correlation degree, and/or may output an inferred value indicating each frame image corresponding to all correlation degrees that are higher than or equal to the threshold correlation degree. However, the form of the inference value that is output by the output module is not limited thereto.

In accordance with many embodiments, among the calculated correlation degrees, when there is no correlation degree that is higher than or equal to the threshold correlation degree that is set for each text, the inference models (and/or the sub-inference models) may terminate the inference for the frame image(s) that were input into the inference models (and/or the sub-inference models).

In accordance with some embodiments, among the calculated correlation degrees, when there is no correlation degree that is higher than or equal to the threshold correlation degree that is set for each text, the inference models (and/or the sub-inference models) may output inferred values for frame image(s) that are input to the inference models with a set probability. In other words, even when it is determined that there is no event similar to the input frame image(s), the inference models may transmit inference values for the frame image(s) to the video generating apparatus(es) with a certain probability. Additionally or alternatively, the video generating apparatus(es) may transmit session identification information and one or more timestamps corresponding to the frame image(s) to a second event queue. Additionally or alternatively, the video generating apparatus(es) may collect the corresponding session identification information and the timestamps stored in the second event queue as negative samples. The negative samples collected in this way may be used for learning to increase the accuracy of inference models in the future. Thus, transmitting the inference values for the frame image(s) in which the inference models determine that there is no similar event to the video generating apparatus(es) with a certain probability may indicate that data can be accumulated for model learning at the same time as the inferences.

Further, in accordance with various embodiments, the content event information identified by the video generating apparatus(es) may include session identification information and the timestamp(s) corresponding to the frame image(s) selected with the consideration of the output of the inference model.

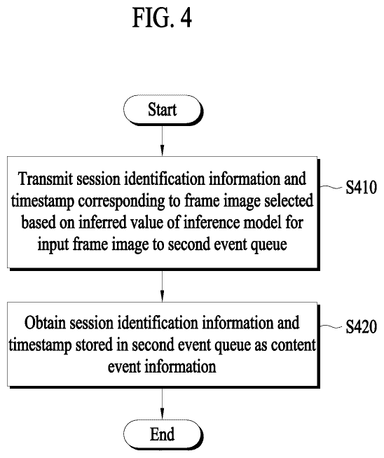

An example process for performing operation S230 in accordance with several embodiments of the invention, is illustrated in FIG. 4. More specifically, as shown in FIG. 4, process S400 transmits (S410) session identification information and a timestamp corresponding to a frame image selected based on an inferred value of the inference model for an input frame image to a second event queue. Process S400 obtains (S420) the session identification information and the timestamp stored in the second event queue as content event information. In accordance with several embodiments, the second event queue may include but is not limited to an architecture based on Apache Kafka.

Referring back to FIG. 2, process S200 identifies (S240) information about selected sections of the target video based on the content event information identified in operation S230.

Process S200 generates (S250) a first extracted video based on the target video and the information about the section selected in operation S240.

In accordance with certain embodiments, the process S200 may transmit the generated first extracted video to one or more viewer terminals or the streamer terminal 200 that is scheduled to transmit the first extracted video.

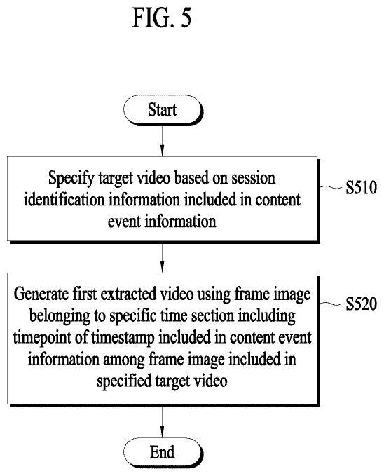

An example process for performing operation S250 in accordance with various embodiments of the invention, is illustrated in FIG. 5. In accordance with many embodiments, as shown in FIG. 5, process S500 specifies (S510) a target video based on session identification information included in the content event information. Process S500 generates (S520) a first extracted video using frame images belonging to a specific time section including timepoints of timestamps included in the content event information among frame images included in the specified target video.

In an example embodiment related to operation S520, a video generating apparatus may determine the time section of the frame images to be used for generating the first extracted video based on the type of event (i.e., an event inferred to correspond to the frame images) that the inference model inferred by receiving the frame images. Specifically, the video generating apparatus may generate the first extracted video using frame images belonging to a time section that is set based on event identification information included in the content event information. Additionally or alternatively, the time section may include the timepoints of the timestamps included in the content event information.

For example, in the case of a frame image from which it is inferred that an event a streamer consuming food occurred, including a timepoint of a timestamp of the frame image, the video generating apparatus may generate the first extracted video as “mukbang highlight” by using frame images belonging to a time section (including but not limited to 30 seconds ahead from the timepoint and 30 seconds behind the timepoint).

In some cases, it may be inferred from a frame image that an event (e.g., a streamer smiling) occurred, including a timepoint of a timestamp of the frame image. In such cases, the video generating apparatus(es) may generate the first extracted video as a “funny scene” by using frame images belonging to a certain time section (e.g., 10 seconds ahead from the timepoint and 5 seconds behind the timepoint).

Further, in accordance with multiple embodiments, when a plurality of content events occur within one session through which video is transmitted, the video generating apparatus(es) may generate one extracted video corresponding to two or more content events based on the interval in which the content events occurred. For example, when two content events occur consecutively within a certain interval, the video generating apparatus(es) may generate one extracted video that can encompass the two content events, rather than generating two extracted videos that are close in time.

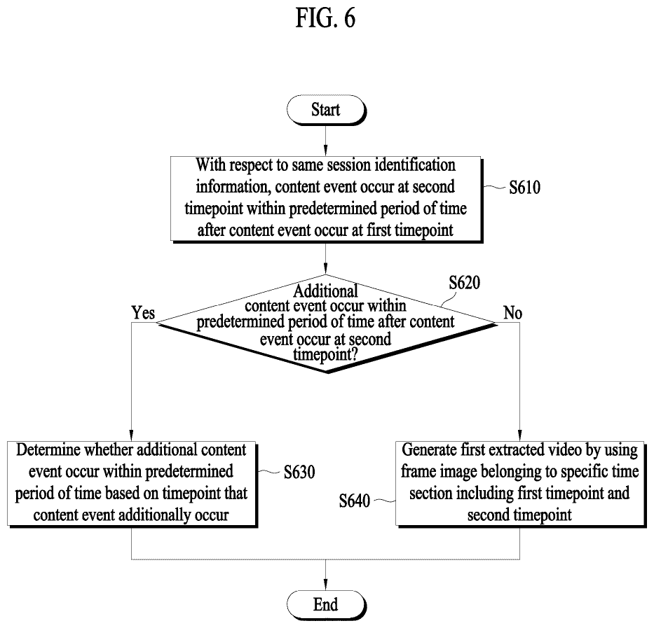

An example process for performing operation S250 in accordance with numerous embodiments of the invention, is illustrated in FIG. 6. With respect to the same session identification information included in the content event information, when process S600 notes (S610) that a content event occurs at a second timepoint within a predetermined period of time after a content event occurs at a first timepoint, process S600 identifies (S620) whether an additional content event occurs within a predetermined period of time after the content event occurs at the second timepoint.

When process S600 determines that an additional content event does occur (e.g., at a third timepoint) within a predetermined period of time after the content event occurs at the second timepoint, process S600 determines (S630) whether an additional content event occurs within a predetermined period of time based on the third timepoint. When no additional content event occurs until a predetermined period of time elapses after the third timepoint, process S600 may generate the first extracted video using the first timepoint as the start timestamp (e.g., start_timestamp) and the third timepoint as the end timestamp (e.g., end_timestamp). When another additional content event occurs at a fourth timepoint within a predetermined period of time after the third timepoint, process S600 may repeat operation S630 based on the fourth timepoint.

Further, when no additional content event occurs within a predetermined period of time after the content event occurs at the second timepoint, process S600 generates (S640) the first extracted video using frame images belonging to a specific time section including the first timepoint and the second timepoint. For example, having a first timepoint as the start timestamp (e.g., start_timestamp) and a second timepoint as the end timestamp (e.g., end_timestamp), process S600 may generate a first extracted video (including but not limited to frame images belonging from M minute before the start_timestamp to N minute after the end_timestamp).

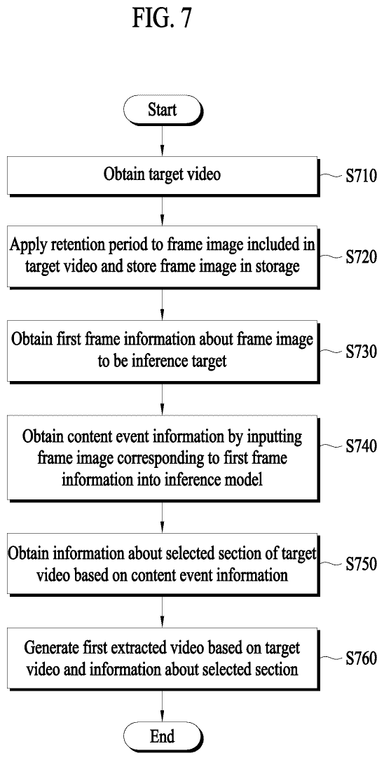

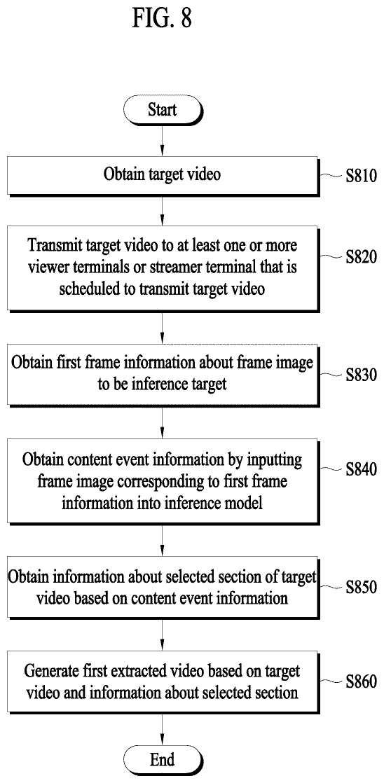

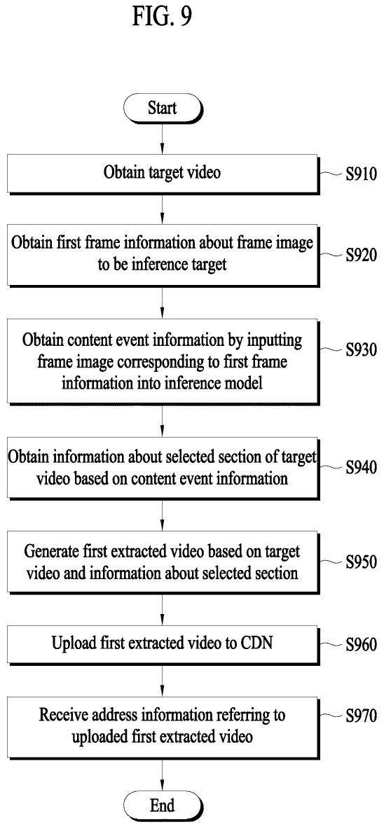

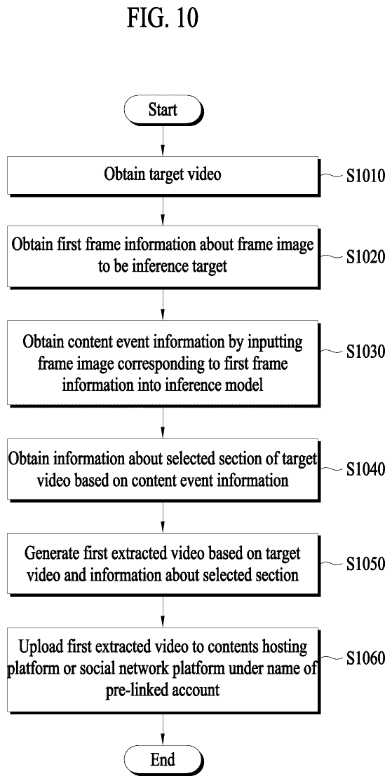

FIGS. 7 to 10 illustrate flowcharts explaining a video generating method performed in accordance with various embodiments. Additionally or alternatively, the video generating method depicted may be performed in a manner related to FIG. 2. Specifically, FIG. 7 is a flowchart related to a process of separately storing an obtained target video. FIG. 8 is a flowchart related to a process of separately transmitting the obtained target video. FIGS. 9 and 10 are flowcharts related to a process of uploading the generated first extracted video to a separate space.

First referring to FIG. 7, process S700 obtains (S710) a target video including a plurality of frame images. Process S700 applies (S720) a retention period to the plurality of frame images included in the target video and store the frame images in storage. This is because the capacity occupied by the frame images included in the target video is quite large, and because it is unlikely that the frame images of the entire target video will be used again except for the frame images that will be used to generate the first extracted video or the second extracted video in the future. Efficient use of storage becomes possible by storing the frame images in the storage by applying a certain retention period and setting the frame images to be automatically deleted when the retention period expires.

Process S700 obtains (S730) first frame information about at least some frame images to be inference targets among the plurality of frame images. Process S700 obtains (S740) content event information for extracting a video with respect to the target video by inputting the frame images corresponding to the first frame information into the inference model. Process S700 obtains (S750) information about the selected section of the target video, based on the content event information. Process S700 generates (S760) the first extracted video using at least some of the frame images stored in the storage, based on the target video and information about the selected section.

Further, referring to FIG. 8, process S800 obtains (S810) a target video including a plurality of frame images. Process S800 transmits (S820) the obtained target video to at least one of the viewer terminal 300-1, the viewer terminal 300-2, . . . , the viewer terminal 300-N and the streamer terminal 200 that is scheduled to transmit the target video. This may be used to relay the entire video (the target video) to viewers or the host of the session through which the video is shared before generating the extracted video, and this allows the viewers or the host to select the video they want to watch among extracted videos and the entire video generated later. The description of operation S830 to operation S860 is omitted since it is the same or similar to operation S730 to operation S760 shown in FIG. 7.

Further, referring to FIG. 9, process S900 obtains (S910) a target video including a plurality of frame images. Process S900 obtains (S920) first frame information about at least some of the frame images to be inference targets among the plurality of frame images. Process S900 obtains (S930) content event information for extracting video from the target video by inputting the frame images corresponding to the first frame information into the inference model. Process S900 obtains (S940), based on the content event information, information about the selected section of the target video. Process S900 generates (S950), based on the target video and information about the selected section, the first extracted video using at least some of the frame images stored in the storage.

Process S900 uploads (S960) the generated first extracted video to the CDN. Process S900 receives (S970) address information referring to the first extracted video uploaded from the CDN.

Specifically, video generating apparatus(es) configured in accordance with numerous embodiments of the invention may receive the address information referring to the first extracted video uploaded to the CDN and transmit information including but not limited to: (1) session identification information corresponding to the first extracted video, (2) a timestamp indicating the start timepoint of the first extracted video, (3) a timestamp indicating the end timepoint of the first extracted video and (4) address information to a server that provides a target video transmission service (for example, a live-streaming service), and/or to a separate database. Further, the server that received the information (e.g., (1) to (4)) above may, additionally or alternatively, store the information in separate databases linked to the server itself. In other words, there can be an advantage where, by uploading the extracted video to the CDN, free access to extracted video can be obtained through the CDN without need to store all of the extracted video (which has a relatively large capacity) in the storage. Instead, only the information from (1) to (4) above (which has a relatively low capacity) may need to be included in the database(s).

Further, referring to FIG. 10, process S1000 obtains (S1010) a target video including a plurality of frame images. Process S1000 obtains (S1020) first frame information about at least some frame images to be inference targets among the plurality of frame images. Process S1000 obtains (S1030) content event information for video extracting with respect to the target video by inputting the frame images corresponding to the first frame information into the inference model. Process S1000 obtains (S1040) information about a selected section of the target video based on the content event information. Process S1000 generates (S1050) a first extracted video using at least some of the frame images stored in the storage based on the target video and information about the selected section.

Process S1000 uploads (S1060) the generated first extracted video to one or more content hosting platforms or social network platforms under a name of a pre-linked account. For example, a video generating apparatus may upload the first extracted video to content hosting platforms such as YouTube, and/or a social network platform including but not limited to Facebook, Instagram, and TikTok. Through the operations, rather than simply automatically creating an extracted video from a target video, the generated extracted video may be automatically uploaded to various platforms to facilitate streamer marketing and revenue generation.

In accordance with some embodiments, the accounts to which the first extracted videos are uploaded may be accounts that the streamer terminals registered in advance on target video transmission service platforms, and/or may be accounts that the streamer terminals registered in advance with the video generating apparatus(es).

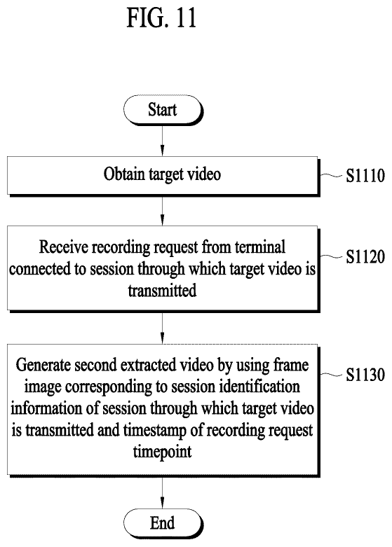

A flowchart illustrating a video generating method performed in accordance with many embodiments of the invention is illustrated in FIG. 11. Specifically, FIG. 11 relates to a method of generating an extracted video according to a recording request. In performing the method, video generating apparatus(es) configured in accordance with various embodiments of the invention may quickly generate extracted videos when specific events occur, including but not limited to when reports are received for abusive behavior on target video transmission services, and/or when large donations (giftings) are made. The video generating method may directly generate extracted video in response to the recording request without the need to infer images through an inference model, and thus, compared to the video generating method depicted in FIG. 2, video generating methods performed in accordance with several embodiments that are based on FIG. 11 may require actions called recording requests, which can reduce automaticity, and have the advantage of saving computing resources required for video generation.

Process S1100 obtains (S1110) a target video including a plurality of frame images.

Process S1100 receives (S1120) a recording request from a terminal connected to the session through which the target video is transmitted. In other words, video generating apparatus(es) configured in accordance with multiple embodiments may receive recording requests from the streamer terminal(s) connected to the session (through which the target video is transmitted) and/or one of the viewer terminals (e.g., viewer terminal 300-1, the viewer terminal 300-2, . . . and the viewer terminal 300-N). The recording requests may, additionally or alternatively, be made through interfaces provided within the target video transmission service. The recording requests may, additionally or alternatively, be made through software or hardware provided in the streamer terminal(s) and/or the viewer terminal(s) to the video generating apparatuses.

Process S1100 generates (S1130) a second extracted video by using frame images corresponding to the session identification information of the session through which the target video is transmitted and the timestamp of the recording request timepoint. In accordance with some embodiments, video generating apparatus(es) may specify the target video based on the session identification information. Additionally or alternatively, the video generating apparatus(es) may generate a second extracted video including frame images belonging to a specific time section including but not limited to the timepoints of the timestamps among frame images included in the specific target video.

Certain example embodiments related to processes including but not limited to the process of separately transmitting and/or storing a target video (described above with reference to FIGS. 7 and 8), and/or the process of uploading an extracted video to a separate space (described above with reference to FIGS. 9 and 10) may, additionally or alternatively, be applied to the video generating method for generating the second extracted video of FIG. 11. As such, redundant explanations regarding them will be omitted.

In the above flowcharts (in FIGS. 2 to 11), methods to be explained are divided into a plurality of operations. However, at least some of the operations may be performed in a different order, may be combined with other operations and performed together, may be omitted, may be divided into detailed operations and performed, and/or may be performed by adding one or more operations that are not illustrated.

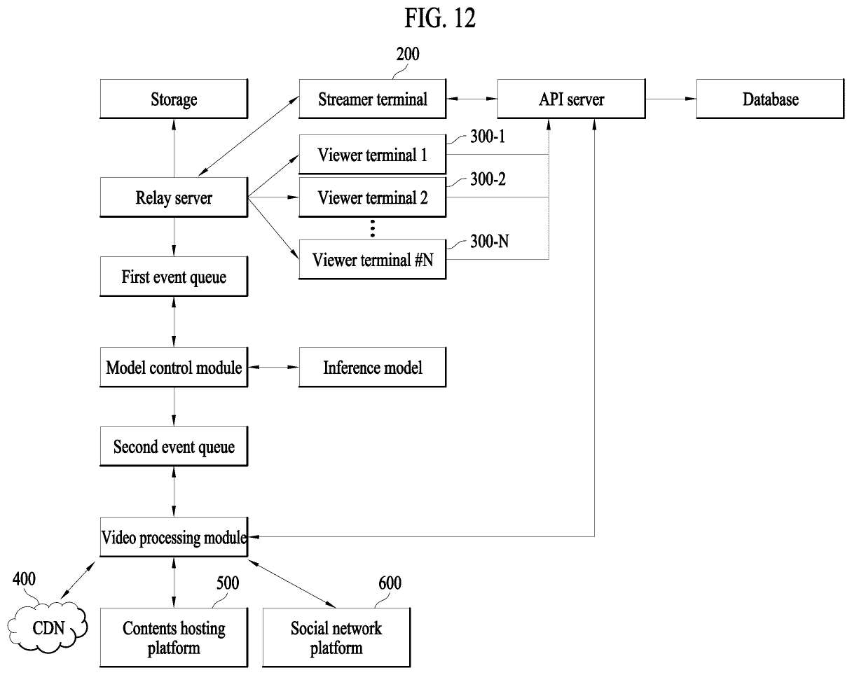

A process for generating an extracted video, performed in accordance with numerous embodiments of the invention is (more intuitively) illustrated and explained in FIG. 12. From the process of FIG. 12, an input/output process, performed in accordance with certain embodiments of the invention, in which inferences are made from inference models is additionally illustrated and explained in FIG. 13.

The video generating process is explained with reference to FIG. 12 as follows:

First, in operation 1-1, when a streamer starts broadcasting through the streamer terminal 200, the streamer terminal 200 may transmit identification information of the streamer to an API server, and may receive session identification information (for example, the identification information of a room where the broadcast takes place) in response. Further, in operation 1-2, the streamer terminal 200 may transmit the broadcast target video and the streamer identification information and/or the session identification information to a relay server. Here, the target video may include but is not limited to an I-frame image and a P-frame image. Meanwhile, transmission between the streamer terminal 200 and the relay server may be performed through Web Real-Time Communication (WebRTC) technology, but is not limited thereto.

Further, in operation 2-1, the relay server may transmit a copy of the received target video to the viewer terminal 300-1, the viewer terminal 300-2, . . . , and the viewer terminal 300-N. In operation 2-2, the relay server may store the I-frame image included in the target video and the P-frame image of the target video in storage. Here, the frame images stored in the storage may be set to be deleted when a retention period (Time to Live: TTL) expires. Further, in operation 2-3, the relay server may transmit at least some of I-frame images included in the target video to a first event queue along with the session identification information and timestamps. Here, considering the possibility that only some of the I-frame images are transmitted to the first event queue may be utilized to efficiently use the costs (computing resources and time) required to generate the extracted video.

Then, in operation 3, the model control module may collect data (the I-frame images, the session identification information and the timestamps) stored in the first event queue.

Finally, in operation 4, the model control module may transmit grouped I-frame images to the inference model based on the session identification information.

A diagram depicting an input/output process of an inference model performed in accordance with multiple embodiments of the invention is illustrated in FIG. 13. Referring to FIG. 13, the inference model(s) configured in accordance with many embodiments may convert each of the texts (for example, “A woman is smiling.” and “A woman is winking.”) defined in relation to a video event into a first embedding vector (an embedding vector of “Awoman is smiling.” and an embedding vector of “A woman is winking.”) through text conversion modules configured in accordance with some embodiments of the invention. Further, the inference model(s) may convert image(s) input into the inference model(s) into a second embedding vector through the image conversion module(s).

Then, the inference model(s) may calculate the correlation degrees between each of the first embedding vectors in a set of first embedding vectors and the second embedding vector by using correlation degree calculation module(s), and the inference model(s) may output an inference value indicating at least one of images corresponding to the correlation degree that is higher than or equal to the threshold correlation degree through output module(s).

Referring back to FIG. 12, in operation 5, the model control module(s) may receive the inference value from the inference model(s), and may transmit session identification information and timestamps corresponding to images indicated by the inferred value to a second event queue.

Further, in operation 6, the video processing module(s) may identify the session identification information and the timestamp(s) stored in the second event queue as content event information.

Further, in operation 7, the video processing module(s) may specify the target video based on the session identification information, and may generate a first extracted video by using frame images belonging to a specific time section including but not limited to the timepoints of the timestamps.

Further, in operation 8, the video processing module(s) may upload the first extracted video to the CDN 400, the contents hosting platform 500 and the social network platform 600.

Further, in operation 9, the video processing module(s) may receive address information referring to the first extracted video from the CDN 400 and transmit the address information to the API server along with the session identification information and the timestamps of the start timepoint and end timepoint of the first extracted video. Further, in operation 10, the API server may store the transmitted data in the database.

Further, some of the operations up to operation 7 described above with reference to FIG. 12 may be performed through video processing systems. Such video processing systems may include but are not limited to storage, a relay server and a video processing server (including but not limited to a first event queue, a model control module, an inference model, a second event queue and a video processing module). Specifically, the video processing systems may include but are not limited to: (1) a relay server that receives a target video containing a plurality of frame images from a streamer terminal that is transmitted through a session established between two or more terminals, and transmits the target video to a video processing server and/or storage; (2) a video processing server that receives the target video from the relay server, obtains first frame information about at least some frame images to be inference targets among the plurality of frame images, inputs frame images corresponding to the first frame image into the inference model to obtain content event information for video extracting with respect to the target video, obtains information about a selected section of the target video based on the content event information, and generates the first extracted video based on the target video and information about the selected section; and (3) storage that receives the target video from the relay server and stores the target video by applying a retention period to the plurality of frame images included in the target video.

Further, differently from the process of generating the first extracted video, in the process of generating the second extracted video, the streamer terminal 200 or the viewer terminal 300-1, the viewer terminal 300-2, . . . and the viewer terminal 300-N may transmit a recording request to the API server. For example, the API server may transmit the session identification information of the session through which the target video is transmitted and a timestamp of the recording request timepoint to the video processing module. The video processing module(s) may generate a second extracted video by retrieving frame image(s) corresponding to the received session identification information and the timestamp from the storage. In other words, the video generating apparatus that generates the second extracted video may be linked to the API server and/or may include the API server itself.

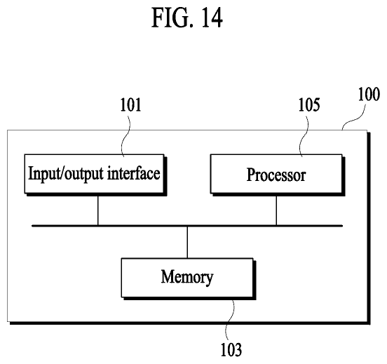

A block diagram explaining a video generating apparatus configured in accordance with certain embodiments of the invention is illustrated in FIG. 14.

The video generating apparatus illustrated in FIG. 14 includes an input/output interface 101, a memory 103 and a processor 105. The video generating apparatus may exchange data between internal modules through the input/output interface 101, and/or may be connected to an external apparatus to exchange data.

The processor 105 may perform at least one method described above with reference to FIGS. 1 to 13. The memory 103 may store information for performing at least one method described above with reference to FIGS. 1 to 13, and the memory 103 may be volatile memory or non-volatile memory.

The processor 105 may control the video generating apparatus to execute programs and provide information. Program codes executed by the processor 105 may be stored in the memory 103.

Connected to the input/output interface 101 and the memory 103, the processor 105 of the video generating apparatus may obtain a target video including a plurality of frame images, identify first frame information about at least some frame images to be inference targets among the plurality of frame images, obtain content event information for extracting a video with respect to the target video by inputting the frame images corresponding to the first frame information into the inference model, obtain information about a selected section of the target video based on the content event information, and generate the first extracted video based on the target video and information about the selected section.

The video generating apparatus illustrated in FIG. 14 shows only elements related to the example embodiments. Therefore, those skilled in the art related to the example embodiments may understand that other general-purpose elements can be included in addition to the elements shown in FIG. 14.

More specifically, the apparatus, as configured in accordance with multiple embodiments and described above, may include a processor, a memory that stores and executes program data, permanent storage such as a disk drive, a communication port to communicate with external apparatus(es)apparatus(es), and user interface apparatus(es)apparatus(es) such as touch panels, keys and buttons. Methods implemented as software modules or algorithms may be stored on a computer-readable recording medium as computer-readable codes or program instructions executable on the processor. Here, computer-readable recording media include magnetic storage media (for example, read-only memory (ROM), random-access memory (RAM), a floppy disk and a hard disk) and optical reading media (for example, a CD-ROM and a digital versatile disc (DVD)). A computer-readable recording medium may be distributed among computer systems connected through a network, and computer-readable codes may be stored and executed in a distributed manner. The medium may be readable by a computer, stored in a memory, and executed by a processor.

Systems and methods configured in accordance with several embodiments may be represented by functional block elements and various processing steps. The functional blocks may be implemented in any number of hardware and/or software configurations that perform specific functions. For example, an example embodiment may adopt integrated circuit configurations, such as memory, processing, logic and/or look-up table, that may execute various functions by the control of one or more microprocessors or other control devices. Similar to that elements may be implemented as software programming or software elements, in accordance with numerous embodiments, systems may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, systems configured in accordance with multiple embodiments may adopt the existing art for electronic environment setting, signal processing, and/or data processing. Terms such as “mechanism,” “element,” “means” and “configuration” may be used broadly and are not limited to mechanical and physical elements. The terms may include the meaning of a series of routines of software in association with a processor or the like.

The above-described example embodiments are merely examples, and other embodiments may be implemented within the scope of the claims to be described later.

What is claimed is:

1. A video generating method comprising:
obtaining a target video comprising a plurality of frame images, wherein the target video is transmitted through a session established between two or more terminals;
obtaining first frame information corresponding to at least some frame images, from among the plurality of frame images, to be inference targets;
inputting the at least some frame images corresponding to the first frame information into an inference model to obtain content event information for extracting at least one extracted video with respect to the target video;
obtaining information about a selected section of the target video based on the content event information; and
generating a first extracted video based on:
the target video; and
information about the selected section.

2. The video generating method of claim 1, wherein obtaining the target video comprises obtaining the target video from a relay server while the target video is transmitted from a streamer terminal to one or more viewer terminals through the relay server.

3. The video generating method of claim 1, wherein obtaining the first frame information comprises:
transmitting, to a first event queue:
the at least some frame images;
session identification information of the session through which the target video is transmitted; and
timestamps corresponding to the at least some frame images; and
obtaining the at least some frame images, the session identification information and the timestamps stored in the first event queue as first frame information.

4. The video generating method of claim 3, wherein transmitting to the first event queue comprises transmitting, to the first event queue:
a selected frame image from the at least some frame images, wherein the selected frame image:
corresponds to an I-frame; and
is selected as an inference target with a predetermined probability;
the session identification information; and
a timestamp corresponding to the selected frame image.

5. The video generating method of claim 1, wherein the at least some frame images corresponding to the first frame information comprise I-frame images grouped based on session identification information of the session through which the target video is transmitted.

6. The video generating method of claim 1, wherein obtaining the content event information comprises:
transmitting, to a second event queue, session identification information and a timestamp corresponding to a particular frame image, wherein the particular frame image is selected based on inferred values of the inference model for the at least some frame images; and
obtaining the session identification information and the timestamp stored in the second event queue as the content event information.

7. The video generating method of claim 1, wherein generating the first extracted video comprises:
specifying the target video based on session identification information included in the content event information; and
from frame images included in the specified target video, generating the first extracted video, wherein:
the first extracted video is generated using frame images belonging to the selected section; and
the selected section comprises timepoints of timestamps included in the content event information.

8. The video generating method of claim 7, wherein the selected section comprises frame images belonging to a time section that:
is set based on event identification information included in the content event information; and
includes the timepoints of the timestamps included in the content event information.

9. The video generating method of claim 1, wherein generating the first extracted video comprises:
when a content event occurs at a second timepoint within a predetermined period of time after a content event occurs at a first timepoint, regarding identical session identification information included in the content event information;
when no additional content event occurs within the predetermined period of time after the content event occurs at the second timepoint, generating the first extracted video using frame images belonging to a time section including the first timepoint and the second timepoint; and
when a content event occurs at a third timepoint within a predetermined period of time after the content event occurs at the second timepoint, determining whether an additional content event occurs within the predetermined period of time based on the third timepoint.

10. The video generating method of claim 1, further comprising applying a retention period to the plurality of frame images included in the target video and storing the plurality of frame images in a storage unit;
wherein the first extracted video is generated using at least some of the plurality of frame images stored in the storage.

11. The video generating method of claim 1, further comprising transmitting the target video to at least one of:
one or more viewer terminals; or
a streamer terminal that is scheduled to transmit the target video.

12. The video generating method of claim 1, further comprising transmitting the generated first extracted video to at least one of:
one or more viewer terminals; or
a streamer terminal that is scheduled to transmit the first extracted video.

13. The video generating method of claim 1, further comprising:
uploading the generated first extracted video to a content delivery network (CDN); and
receiving address information referring to the uploaded first extracted video.

14. The video generating method of claim 1, further comprising uploading the generated first extracted video to one or more contents hosting at least one of:
platforms under a name of a pre-linked account; or
social network platforms under the name of the pre-linked account.

15. The video generating method of claim 1, wherein the inference model:
receives frame images included in each of a plurality of different target videos in batch form; and
infers whether each frame image is a frame image suitable for serving as reference for video extraction.

16. The video generating method of claim 1, wherein the inference model individually receives one or more frame images included in a second target video and infers whether each frame image of the one or more frame images is suitable for serving as reference for video extraction.

17. The video generating method of claim 1, wherein the inference model comprises:
a first sub-inference model that:
receives a set of frame images included in each of a plurality of different target videos in batch form; and
firstly infers whether each frame image in the set of frame images is suitable for reference for video extraction; and
a second sub-inference model that:
receives at least one frame image determined to be a reference for video extraction according to a result of the first inference by the first sub-inference model, individually for each of the plurality of different target videos; and
secondly infers whether each frame image in the set of frame images is suitable for serving as a reference for video extraction.

18. The video generating method of claim 1, wherein the inference model comprises:
a text conversion module that converts each of one or more texts defined in relation to a content event into a first embedding vector;
an image conversion module that converts a particular frame image that is input to the inference model into a second embedding vector;
a correlation degree calculation module that calculates correlation degrees between the first embedding vector and the second embedding vector; and
an output module that, when a correlation degree that is higher than or equal to a threshold correlation degree that is set for each of the one or more texts is present among the calculated correlation degrees, outputs an inferred value indicating at least one frame image corresponding to the correlation degree that is higher than or equal to the threshold correlation degree.

19. An apparatus comprising:
an input/output interface;
a memory for storing instructions; and
a processor,
wherein the processor, connected to the input/output interface and the memory, is configured to:
obtain a target video comprising a plurality of frame images;
obtain first frame information corresponding to at least some frame images, from among the plurality of frame images, selected to be inference targets;
input the at least some frame images corresponding to the first frame information into an inference model to obtain content event information for extracting at least one extracted video with respect to the target video;
obtain information about a selected section of the target video based on the content event information; and
generate a first extracted video based on: the target video, and information about the selected section.

20. A video processing system comprising:
a relay server that receives from a streamer terminal a target video comprising a plurality of frame images that is transmitted through a session established between two or more terminals, and that transmits the target video to a video processing server and/or a storage unit;
a video processing server that receives the target video from the relay server, obtains first frame information corresponding to at least some frame images, selected to be inference targets, inputs frame images corresponding to the first frame information into an inference model to obtain content event information for extracting a video with respect to the target video, obtains information about a selected section of the target video based on the content event information, and generates a first extracted video based on the target video and information about the selected section; and
a storage unit that receives the target video from the relay server and stores the target video by applying a retention period to the plurality of frame images included in the target video.
